(19) United States
(12) Patent Application Publication
(10) Pub. No.: US 2026/0046960 A1
(43) Pub. Date: Feb. 12, 2026

(54) METHODS, ARCHITECTURES, APPARATUSES AND SYSTEMS FOR DUALSTEER DEVICES

(71) Applicant: InterDigital Patent Holdings, Inc., Wilmington, DE (US)

(72) Inventors: Guanzhou Wang, Brossard (CA); Xavier De Foy, Kirkland (CA); Taimoor Abbas, Sainte-Julie (CA); Magurawalage Chathura Madhusanka Sarathchandra, London (GB); Anuj Sethi, Ottawa (CA); Rocco Di Girolamo, Laval (CA)

(21) Appl. No.: 18/798,635

(22) Filed: Aug. 8, 2024

(51) Int. Cl. H04W 76/15; H04W 24/02; H04W 24/10; H04W 88/06

(52) U.S. Cl. CPC H04W 76/15; H04W 24/02; H04W 24/10; H04W 88/06

(57) ABSTRACT

Wireless transmit/receive unit (WTRU) methods and systems are provided. A WTRU transmits a request to establish a first protocol data unit (PDU) session over a first wireless network and receives, from the first wireless network, information for triggering a performance management function (PMF) measurement for the first PDU session. The WTRU determines to perform the PMF measurement based on the information and performs the PMF measurement to obtain a parameter associated with the PMF measurement. The WTRU further determines whether the parameter satisfies at least one criterion and, in response to determining that the parameter satisfies the at least one criterion, transmits a request to establish a second PDU session over a second wireless network.

### TECHNICAL FIELD

The present disclosure is generally directed to the fields of communications, software and encoding, including, for example, to methods, architectures, apparatuses, systems related to DualSteer devices.

### SUMMARY

In certain representative embodiments, a method is performed by a wireless transmit/receive unit (WTRU) is provided. The method may comprise transmitting a request to establish a first protocol data unit (PDU) session over a first wireless network; receiving, from the first wireless network, information for triggering a performance management function (PMF) measurement for the first PDU session; determining to perform the PMF measurement based on the information; performing the PMF measurement to obtain a parameter associated with the PMF measurement; determining that the parameter satisfies at least one criterion; and in response to determining that the parameter satisfies the at least one criterion, transmitting a request to establish a second PDU session over a second wireless network.

In certain representative embodiments, a WTRU comprising a processer, and a transceiver coupled to the processer is provided. The WTRU may be configured to: transmit a request to establish a first protocol data unit (PDU) session over a first wireless network; receive, from the first wireless network, information for triggering a performance management function (PMF) measurement for the first PDU session; determine to perform the PMF measurement based on the information; perform the PMF measurement to obtain a parameter associated with the PMF measurement; determine that the parameter satisfies at least one criterion; and in response to determining that the parameter satisfies the at least one criterion, transmit a request to establish a second PDU session over a second wireless network.

In certain representative embodiments, a PMF measurement configuration is provided to a wireless network node (e.g., a Wireless Transmit/Receive Unit). The WTRU may initiate PMF measurement on a PDU Session based on conditions specified in the PMF measurement configuration (e.g., PMF assistance information) and local radio signal measurements or based on an explicit Performance Measurement Function Protocol (PMFP) command received from a network. The PMF measurement result may be used to determine whether to establish a second PDU Session over a second 3GPP access.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a DualSteer service according to one or more embodiment;

FIG. 3 illustrates a procedure for starting a PMF measurement according to one or more embodiments;

FIG. 4 illustrates a procedure for starting a PMF measurement according to one or more embodiments;

FIG. 5 illustrates a procedure for a PMF measurement according to one or more embodiments; and

FIG. 6 is a flow chart illustrating a method for PMF Enhancements for DualSteer Operations according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

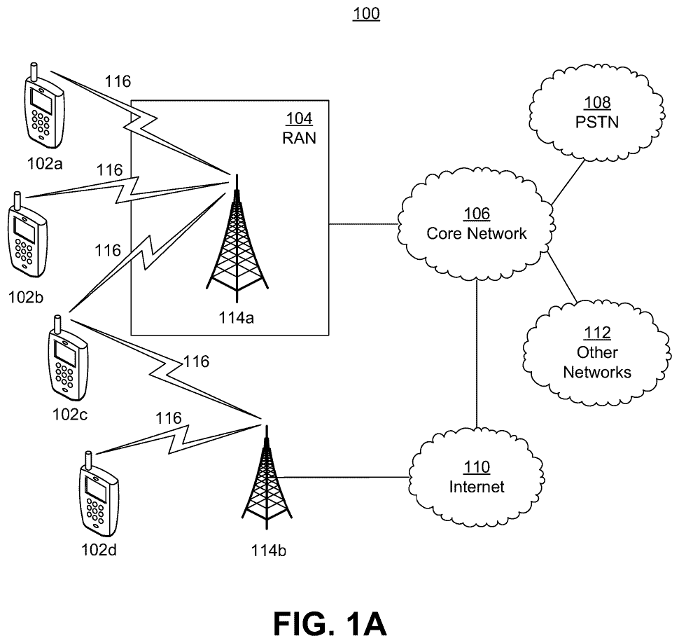

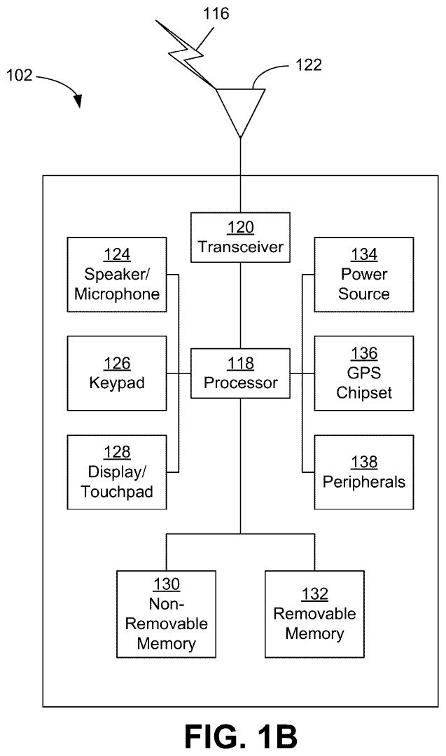

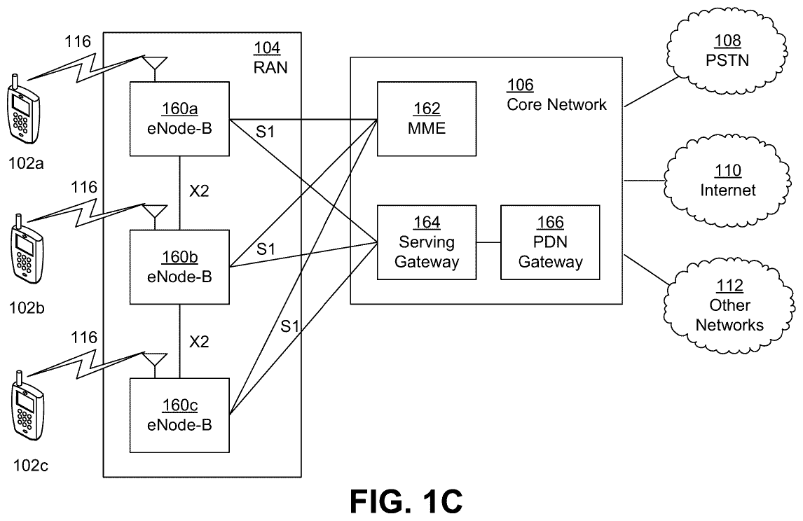

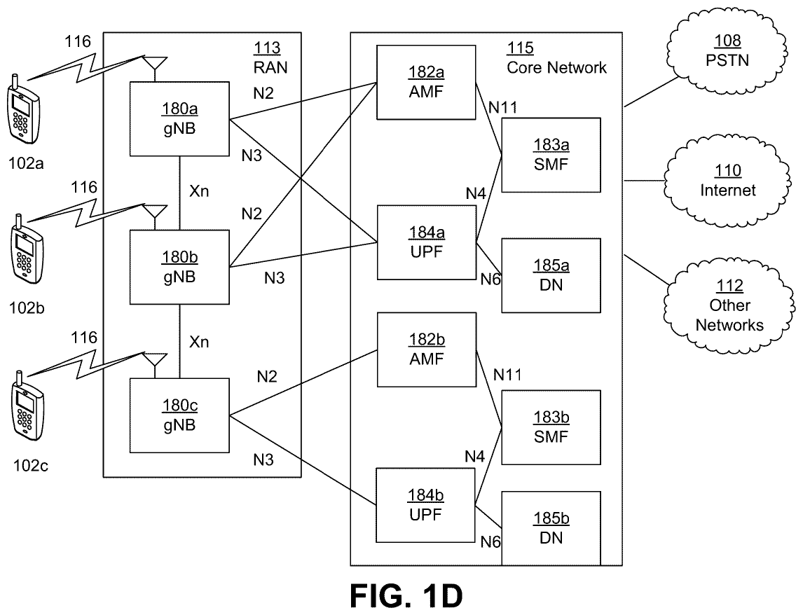

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### DualSteer Service

In certain representative embodiments, mechanisms that enable traffic steering, switching and splitting between a 3rd Generation Partnership Project (3GPP) access network (e.g., Evolved Universal Terrestrial Radio Access (E-UTRA) or New Radio (NR)) and a non-3GPP access network (e.g., WiFi) are provided. An example mechanism may be Access Traffic Steering, Switching & Splitting (ATSSS) feature. In certain representative embodiments, new mechanisms to support traffic steering and switching over two 3GPP access networks is provided.

In certain representative embodiments, there may be various scenarios of two 3GPP access types (e.g., NR, Non-Terrestrial NR, E-UTRA) and the network types (e.g., Home-Public Land Mobile Network (H-PLMN), Visited-Public Land Mobile Network (V-PLMN), Public Network Integrated-Non-Public Network (PNI-NPN)) that the 3GPP access networks may be connected to.

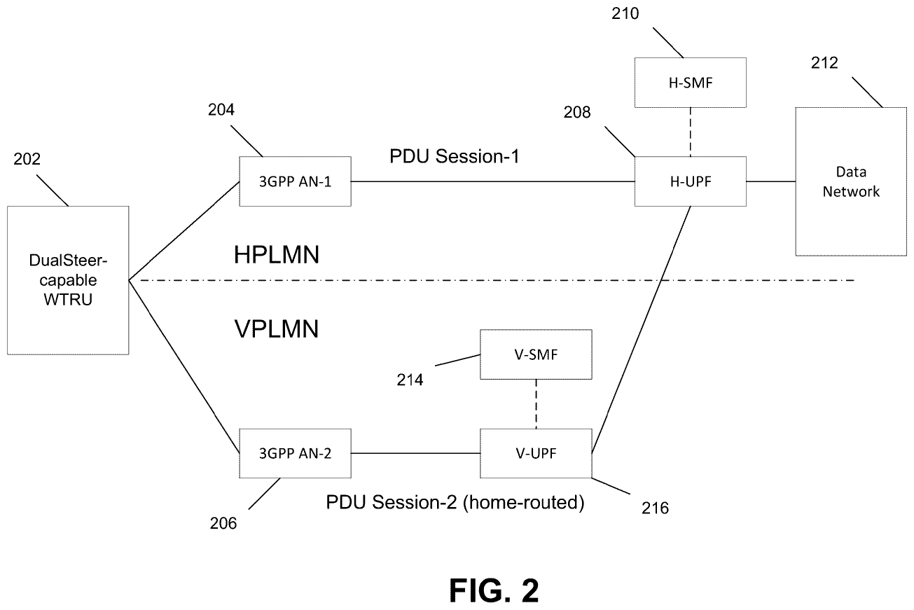

In certain representative embodiments, a 5G Core Network 5GC architecture enhancement and procedures to support DualSteer services in 3GPP is provided. FIG. 2 illustrates a DualSteer service comprising two PDU Sessions according to one or more embodiments. In certain representative embodiments, as illustrated in FIG. 2, a DualSteer-capable WTRU 202 may establish two separate Protocol Data Unit (PDU) Sessions over two 3GPP access networks 204, 206 to enable traffic steering and switching. The two access networks 204, 206 may be in the same PLMN or two PLMNs. In certain representative embodiments, one access network 204 may be in the HPLMN and another access network 206 may be in the VPLMN. In certain representative embodiments the two separate PDU Sessions may be anchored in the same User Plane Function (UPF) 208 in the HPLMN connected to a Data Network 212. In other words, if one PDU Session is established over an access network 206 of a VPLMN, that PDU Session may need to be home-routed and anchored in a common UPF 208 in HPLMN. The HPLMN may further comprise a Home Session Management Function H-SMF 210. The VPLMN may further comprise a Visited Session Management Function V-SMF 214.

### Access Network Performance Measurement

In certain representative embodiments, access network performance measurement may be introduced to support ATSSS operations. The WTRU and the PMF which resides in the anchor UPF of a Multi-Access (MA) PDU Session may exchange Performance Measurement Function Protocol (PMFP) messages/packets over the 3GPP access and non-3GPP access of the MA PDU Session to measure the access network performances such as Round-Trip Time (RTT) and Packet Loss Rate (PLR). The WTRU and the UPF may use the Performance Measurement Function (PMF) measurement result to make traffic steering, switching and splitting decisions, depending on the Steering Mode that's specified for a Service Data Flow (SDF).

In certain representative embodiments, when the MA PDU Session is established, the network (SMF) may provide the WTRU with the PMF Assistance Information which may include the PMF address/port information. A different port may be assigned for 3GPP access and non-3GPP access respectively. The WTRU may use the PMF Assistance Information to specify the destination address/port of its uplink PMFP messages. On the downlink direction, the UPF may use the source address/port of the received PMFP messages and use them as the destination address/port of the DL PMFP messages sent to the WTRU.

In certain representative embodiments, a WTRU may start PMF measurement on a PDU Session based on conditions specified in the PMF assistance information and local radio signal measurements or based on explicit PMFP command received from the network. The PMF measurement result is used to determine whether to establish a second PDU Session over a second 3GPP access.

In certain representative embodiments, the WTRU may simultaneously perform PMF measurement on two separate PDU Sessions over two 3GPP access network when the PMF measurement is triggered over one of the PDU Sessions.

In certain representative embodiments, a network may provide PMF measurement compensation value which the WTRU may take into account when comparing PMF measurement results of two 3GPP access networks to make traffic steering/switching decisions.

### PMF Measurement for DualSteer Operation

In certain representative embodiments, in ATSSS operations, a WTRU and the network may try to establish both User Plane (UP) paths on 3GPP access and non-3GPP access at the same time, as long as the accesses are available, with a single MA PDU Session establishment procedure. And PMF measurements may only performed when both UP paths on 3GPP access and Non-3GPP access are available. DualSteer operations may involve establishing two separate PDU Sessions over two different 3GPP access networks, in the same or different PLMNs. The establishment of the two PDU Sessions over two 3GPP access networks may not necessarily happen at the same time. This may be because keeping registered/connected through a 3GPP access network is relatively costly (e.g. in terms of battery consumption). The DualSteer-capable WTRU/device may decide to connect to a second 3GPP access only when it's necessary. For example, it may measure the performance of the first 3GPP access network that it's currently connected, using the PMF measurement procedures, and if the measurements (e.g. RTT or PLR) shows the currently connected access network is underperforming, the WTRU may initiate the access of the second 3GPP access network and switch the traffic to the new access network.

The PMF procedures may be performed on a single-access PDU Session as opposed to its original design (i.e., to be performed on two UP paths over 3GPP access and non-3GPP access). In this case, the PMF measurement results may be used for a DualSteer-capable WTRU to determine whether it's necessary to connect to a second 3GPP access. In certain representative embodiments, a new configuration of PMF information (e.g., PMF address and port) and a new management of PMF procedures (e.g., when to start/stop PMF procedures) are provided.

The PMF may also be performed on two separate PDU Sessions if the WTRU decides to connect to a second 3GPP access and establish a new PDU Session over the second 3GPP access. In this case, PMF measurement results may be used to compare the performance of two 3GPP access network for traffic steering and switching purposes. In certain representative embodiments, additional PMF management information is provided as second PDU Session is added for PMF measurement. There may be a variety of 3GPP access Radio Access Technologies (RAT)s, from the recent 5G NR, 5G Non-Terrestrial Network New Radio (NTN-NR), to legacy Long Term Evolution (LTE), Universal Mobile Telecommunications System (UMTS), etc. A DualSteer-capable WTRU/device may support multiple 3GPP RATs. There may be intrinsic discrepancies of average performance metrics (e.g., RTT) among these different RATs. For example, 5G NR may, on average, be superior to UMTS in terms of RTT and PLR in normal conditions. Moreover, in some cases, two PDU Sessions may be significantly different in their UP paths which may impact the PMF measurement result. For example, if one PDU Session is established over the 3GPP access of its HPLMN and the second PDU Session is established over the second 3GPP access of a VPLMN and is home-routed to the H-UPF in the HPLMN. There may be an additional tunnel segment between V-UPF and H-UPF that will introduce extra delay (depending on the physical distance between the V-UPF and H-UPF and the number of routing/forwarding devices in-between), which may make RTT measurement of the second 3GPP access always worse than the first 3GPP access. For these reasons, it may not be desirable to make the traffic steering/switching decisions just based on the absolute PMF measurement results. In certain representative embodiments, a weight factor or compensation may be provided when comparing PMF measurement results of the two 3GPP access networks.

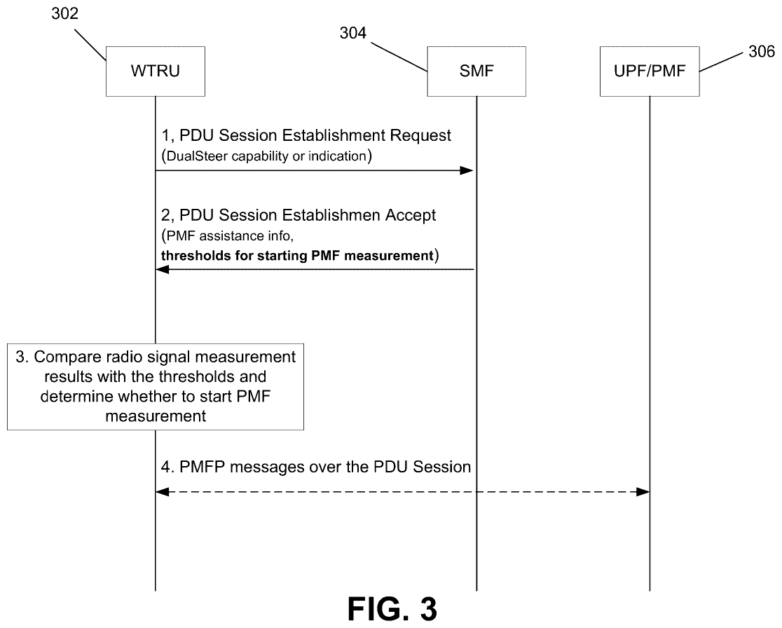

FIG. 3 illustrates a procedure for starting a PMF measurement based on radio signal measurement according to one or more embodiments. In certain representative embodiments, as illustrated in FIG. 3, when a WTRU 302 requests a PDU Session establishment at step 1 and the WTRU indicates it's capable of DualSteer service to an SMF 304 of a network, or when the PDU Session is subject to DualSteer operations, the network (e.g. SMF 304) may send PMF Assistance Information to the WTRU when the PDU Session is successfully established, e.g., in PDU Session Establishment Accept message at step 2. In addition to PMF address and port information, the PMF Assistance information may also include conditions, such as radio signal strength/quality thresholds (e.g., a reference signal received power (RSRP) threshold, reference signal received quality (RSRQ) threshold or signal-to-interference ratio (SINR) threshold), that may be used by the WTRU to determine when to start PMF measurement procedures over the PDU Session. In certain representative embodiments, multiple thresholds may be provided, in this case the provided thresholds may be assigned different priorities. A lower priority threshold may only be considered when the measurement corresponding to the higher priority threshold is not available. In certain representative embodiments, if the PMF Assistance Information includes a RSRP-threshold, the WTRU may start PMF measurement procedures (for RTT or PLR or both) if the lower layer reported RSRP measurement value is lower than the RSRP-threshold. If there are multiple thresholds in the PMF Assistance Information, the assistance information may additionally indicate whether any of the thresholds may be considered for starting PMF measurement procedures, or all or combinations of the thresholds should be considered. For example, if both RSRP-threshold and RSRQ threshold are included in the assistance information, and it is indicated that both thresholds should be considered, the WTRU may only start PMF measurement when both RSRP and RSQP measurements drop below the thresholds. The WTRU may also consider other conditions, such as if another 3GPP access network is available or not. For example, the WTRU may start PMF measurement when RSRP measurement drops below the threshold and there is another 3GPP access available.

At step 3, the WTRU may compare radio signal measurement results with the thresholds and determine whether to start PMF measurement.

After the PMF measurement has been started, the WTRU may continue to compare the radio signal measurement with the configured thresholds. If the condition to start the PMF measurement is not satisfied anymore, the WTRU may stop the PMF measurement.

At step 4, PMFP messages over the PDU Session may be transmitted and received between the WTRU 302 and a UPF/PMF 306.

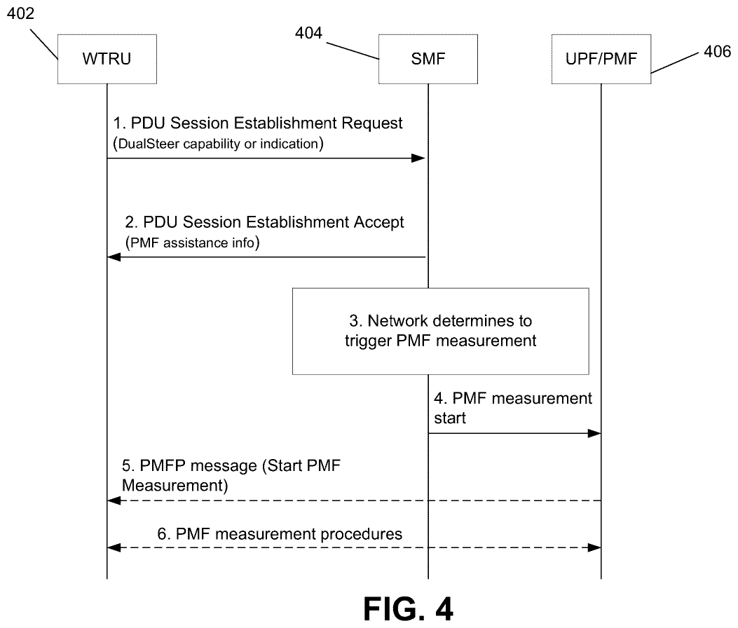

FIG. 4 illustrates a procedure for starting a PMF measurement based on explicit PMFP command according to one or more embodiments. In certain representative embodiments, as illustrated in FIG. 4, a WTRU 402 may transmit a PDU session Establishment Request at step 1 and receive a PDU Session Establishment Accept from a SMF 404 at step 2. The PDU Session Establishment Accept may include PMF Assistance Information that further includes the PMF address and port information. The WTRU 402 may also receive a PMF message, “PMFP Start Measurement” at step 5, from the network over the PDU Session which commands the WTRU to start PMF measurement. The network may issue such a command when it observes the deterioration of the access network performance, such as congestion or overload in the access network and determines to trigger PMF measurement at step 3. The “PMFP Start Measurement” message may also include the metrics (RTT or PLR or both) that the WTRU should start to measure. At step 4, the SMF 404 may transmit a PMF measurement start message to UPF/PMF 406. At step 6, the WTRU 402 and the UPF/PMF 406 may perform a PMF measurement procedures.

In certain representative embodiments, the PMFP message may also specify a time duration for which the WTRU shall do the PMF measurement. Upon receiving the “PMFP Start Measurement” message, the WTRU 402 may start performing PMF measurement for the specified metrics and time duration.

In certain representative embodiments, a WTRU may receive a PMF message, “PMFP Stop Measurement”, from a network over the PDU Session which commands the WTRU to stop PMF measurement.

In certain representative embodiments, any PMF measurement message received from a network, which implies the network has started network-side PMF measurement, may trigger a WTRU to start WTRU-side PMF measurement, even when no explicit “PMFP Start Measurement” command is received. In certain representative embodiments, the WTRU may receive a network initiated PMFP Echo Request message from the network, which implies that the network has started RTT measurement. Accordingly, the WTRU may start its own RTT measurement procedure by sending PMFP Echo Request to the network.

In certain representative embodiments, a PMF measurement may also be performed periodically during the lifetime of the PDU Session. The PMF Assistance Information may indicate a timer value that may be used by the WTRU to start PMF measurement periodically. The PMF Assistance Information may also indicate a time duration that each PMF measurement procedure may last. The WTRU may also determine, based on its own implementation, the period and the duration of each period for PMF measurement.

In certain representative embodiments, when a WTRU has started performing PMF measurement, the measurement results (e.g., RTT, PLR) may be used for the WTRU to determine whether to register/connect to a second 3GPP access network, or activate or establish a second PDU session on a second 3GPP access network. In certain representative embodiments, the WTRU may be configured with a multi-access rule that specifies a PMF-measurement-based condition that the WTRU may access a second 3GPP access network and establish a second PDU Session over the second 3GPP access network. In certain representative embodiments, the multi-access rule may specify that if the measured RTT is greater than a certain threshold, the WTRU should try to establish a second PDU Session over the second 3GPP access network. The WTRU may follow the rule to start connecting to a second 3GPP access network once the PMF measurement-based condition is met.

In certain representative embodiments, a method is provided to enable a WTRU to start PMF measurement on a PDU Session by a normal WTRU (i.e., non-DualSteer-capable WTRU) to perform PMF measurement on a normal PDU Session. The PMF measurement on a normal PDU Session may still be beneficial, e.g. for the network decision to handover/redirect the WTRU to another RAN/cell or another type of access, etc.

### PMF Management for the Second 3GPP Access/PDU Session

In certain representative embodiments, when a DualSteer-capable WTRU establishes a second PDU Session over the second 3GPP access to enable DualSteer service steering/switching/splitting, there may be different scenarios for PMF management for the second PDU Session.

In certain representative embodiments, the network has not provided the WTRU any PMF assistance information for the first PDU Session over the first 3GPP access. The network may provide PMF assistance information (e.g., PMF address and port) after the successful completion of the second PDU Session establishment. And the WTRU may use the received PMF assistance information for both the first PDU Session and the second PDU Session, i.e., the WTRU may send/receive PMF messages/packets over the first PDU Session and the second PDU Session to/from the common PMF address/port at the network side. At the network side, the PMF/UPF may be provided with the information (e.g., by the SMF) that two PDU Sessions are coordinated for DualSteer operations. Therefore, the network-side PMF is able to determine which 3GPP access the received PMF messages/packets are associated with by different PDU Session IP address (which is the source IP of the WTRU sent PMF messages/packets).

In certain other representative embodiments, the network has provided the WTRU the PMF assistance information for the first PDU Session over the first 3GPP access. The network may not provide new PMF assistance information for the second PDU Session. The WTRU may use the previous PMF assistance information for the second PDU Session. The WTRU may send/receive PMF messages/packets over the first PDU Session and the second PDU Session to/from the common PMF address/port at the network side. The network-side PMF may be able to determine which 3GPP access the received PMF messages/packets are associated with by different PDU Session IP address.

In certain other representative embodiments, the network has provided the WTRU the PMF assistance information for the first PDU Session over the first 3GPP access and the network may provide new PMF assistance information for the second PDU Session. The content (PMF address, port, etc.) of new PMF assistance information may be different from or the same as the previous PMF assistance information. The WTRU may send/receive PMF messages/packets over the first PDU Session and the second PDU Session to/from two different PMF addresses/ports at the network side.

The two PDU Sessions on two 3GPP access networks may be designated two statuses, with one being Primary PDU Session and the other one Secondary PDU Session. In certain representative embodiments, the PDU Session that's associated with the WTUR's primary subscription (or primary UICC, or primary SUPI), may be considered as the Primary PDU Session. Or, the PDU Session that's established first may be considered as the Primary PDU Session. After the two PDU Sessions are available, the PMF measurement are usually performed simultaneously on both PDU Sessions so the results can be compared and the decisions for DualSteer operations (e.g., moving one SDF to the other PDU Session) can be made based on the PMF measurement result comparisons. The start and duration of the PMF measurement on both PDU Sessions can be determined based as the following:

The WTRU may determine to start PMF measurement based on specific PMF Assistance Information of each PDU Session. And if the UE determines to start PMF measurement on one PDU Session, it may perform PMF measurement on both PDU Sessions. For example, if the RSRP of the first access network (where the Primary PDU Session is established) drops below the configured threshold, the WTRU may start PMF measurement on both Primary and Secondary PDU Sessions. And some SDFs may be switched to the secondary PDU Session according to the PMF measurement result and the DualSteer rules. After a while, if the RSRP of the second access network (where the Secondary PDU Session is established) drops below the configured threshold, the WTRU may start PMF measurement on both Primary and Secondary PDU Sessions. And some SDFs may be switched back to the Primary PDU Session according to the PMF measurement result and the DualSteer rules.

In certain representative embodiments, where all traffic is switched to one PDU Session (e.g., from the Primary PDU Session to the Secondary PDU Session), the WTRU may maintain the other PDU Session (e.g. the Primary PDU Session) for the purpose of performing PMF measurement on that PDU Session. If the PMF measurement result of the PDU Session that has no traffic improves and is better than the other PDU Session, the traffic may be switched back to this PDU Session.

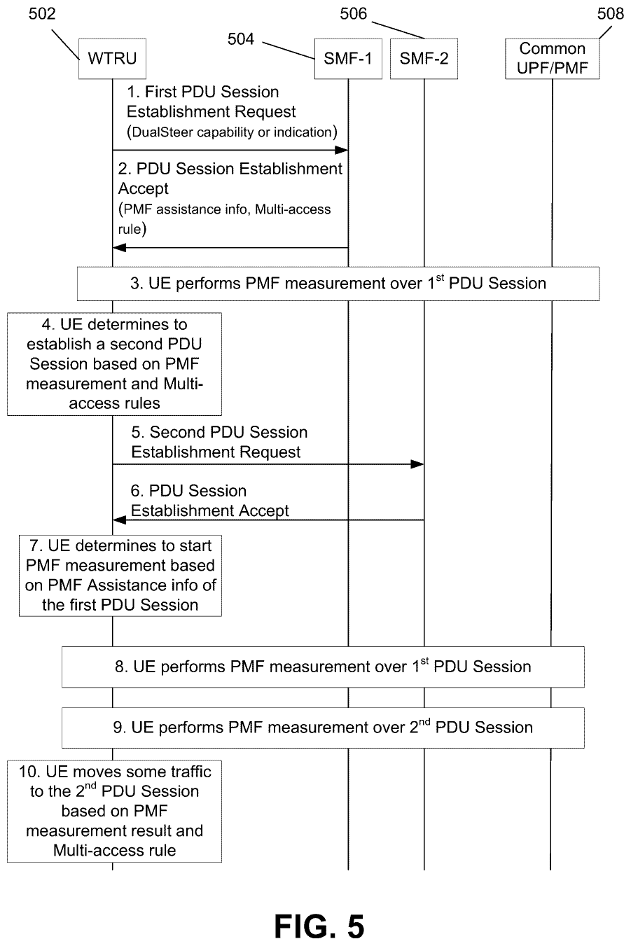

FIG. 5 illustrates an embodiment for simultaneous PMF measurement on two separate PDU Sessions based on a trigger on one of the PDU Sessions according to one or more embodiments.

At step 1, a DualSteer-capable WTRU 502 may request to establish a first PDU Session over a first 3GPP access network in a first PLMN.

At step 2, a SMF-1 504 in the first PLMN may accepts the PDU Session establishment, and provides a PMF Assistance Information and Multi-access rule/policy to the WTRU 502. The PMF assistance information may include a PMF address/port info and conditions (e.g. radio signal measurement thresholds) for triggering PMF measurements. The Multi-access Rule may indicate conditions (e.g., based on the PMF measurement) for triggering the establishment of a second PDU Session over a second 3GPP access, and conditions (e.g., based on the PMF measurement) for switching certain traffic to another 3GPP access network.

At step 3, The WTRU 502 may start PMF measurement on the first PDU Session when the condition specified in the PMF Assistance Information is satisfied.

At step 4, based on the PMF measurement result and the conditions specified in the Multi-access Rule, the WTRU 502 may determine to establish a second PDU Session over a second 3GPP access network.

At step 5, the WTRU 502 may access the second 3GPP access network, performs registration (not shown in the figure) and requests to establish a second PDU Session over the second 3GPP access network in a second PLMN.

At step 6, a SMF-2 506 in the second PLMN may accept the PDU Session establishment. The second PDU Session is associated with the first PDU Session at the WTRU 506 and the network for DualSteer operations.

At step 7, according to the conditions specified in the PMF Assistance Information received for the first PDU Session, the WTRU 502 may determine to start PMF measurement.

At steps 8 and 9, because there are two PDU Sessions that are correlated/associated for DualSteer operations, the WTRU 502 may perform PMF measurement simultaneously on both PDU Sessions over two 3GPP access networks.

At step 10, based on the PMF measurement result and the conditions specified in the Multi-access Rule, the WTRU 502 may determine to switch certain traffic from the first PDU Session to the second PDU Session.

### PMF Measurement Compensation

In certain representative embodiments, DualSteer operations (traffic steering, switching or splitting) may be based on PMF measurement results of two 3GPP access networks involved. However, sometimes the absolute measurement result may not reflect the true performance of the access networks as explained above. The DualSteer operation decisions based on absolute measurement results may not be optimal. To address this issue, the network (e.g., H-SMF in the HPLMN) may configure a “compensation” or “weight” value for one or multiple PMF measurement metrics (e.g., RTT, PLR) for a specific access network.

In certain representative embodiments, a WTRU may establish a first PDU Session over 5G NR of the HPLMN and a second PDU Session over LTE of a VPLMN which is home-routed to the HPLMN. The second PDU Session has an extra GTP tunnel between the V-UPF and H-UPF, which will introduce additional constant delay when it comes to RTT measurement. Therefore, even when the performance of the 5G NR of the HPLMN has deteriorated, the absolute RTT measurement of the first PDU Session may still show better than the second PDU Session due to the extra delay of the second PDU Session. In this case, the network may configure a “RTT compensation” value “x” (milliseconds) as part of PMF assistance information. Assume the absolute RTT measurement of the first PDU Session is “RTT1” and the absolute RTT measurement of the second PDU Session is “RTT2”, when the WTRU compares the RTT measurement of two PDU Sessions, it may compare “RTT1” and “RTT2-x” instead of comparing “RTT1”and “RTT2”. Similar principle can be applied to other PMF metrics such as PLR.

In certain representative embodiments, the network may determine the PMF measurement compensation value for a specific access network based on its statistics (e.g. Operations, Administration, and Maintenance (OAM) data collected from the WTRU's Minimization of Drive Tests (MDT) report in real time or optimized using the OAM data collected over a longer period of time to compensate better for the long term variations) or Network Data Analytics Function (NWDAF) analytics, access network characteristics, PDU session path (home routed vs local breakout).

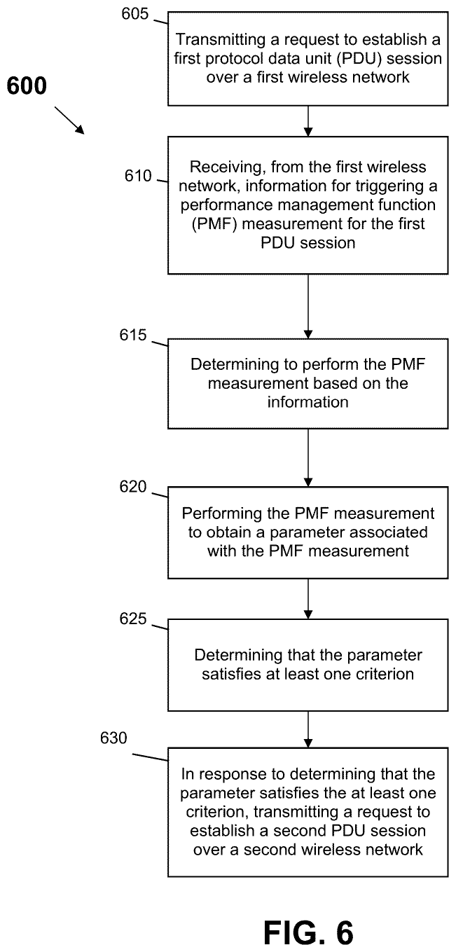

FIG. 6 is a flow chart illustrating a method 600 for PMF Enhancements for DualSteer Operations according to one or more embodiments. The method 600 may be performed by a wireless transmit/receive unit (WTRU), such as the WTRU 102 of FIG. 1B and the WTRU 202 of FIG. 2. The method 600 may include transmitting 605, a request to establish a first protocol data unit (PDU) session over a first wireless network. In some embodiments, the transmitting 605 corresponds to step 1 of FIGS. 3 to 5. The method 600 may include receiving 610, from the first wireless network, information for triggering a performance management function (PMF) measurement for the first PDU session. In some embodiments, the receiving 610 corresponds to step 2 of FIG. 3 and step 2 of FIG. 5. The method 600 may include determining 615, to perform the PMF measurement based on the information. In some embodiments, the determining 615 corresponds to step 3 of FIG. 3 and step 3 of FIG. 5. The method 600 may include performing 620, the PMF measurement to obtain a parameter associated with the PMF measurement. The method 600 may include determining 625, that the parameter satisfies at least one criterion. In some embodiments, the determining 625 corresponds to step 4 of FIG. 5. The method 600 may include transmitting 630, in response to determining that the parameter satisfies the at least one criterion, a request to establish a second PDU session over a second wireless network. In some embodiments, the transmitting 630 corresponds to step 5 of FIG. 5.

In some implementations, criterion information indicative of the at least one criterion may be received from the first wireless network.

In some implementations, the information may comprise at least one of a reference signal received power (RSRP) threshold, reference signal received quality (RSRQ) threshold or signal-to-interference ratio (SINR) threshold, and wherein the at least one criterion is a Round-Trip Time (RTT) threshold and/or a Packet Loss Rate (PLR) threshold.

In some implementations, the parameter may be associated with at least one of a round-trip time (RTT) or a packet loss rate (PLR).

In some implementations, the determining 615 to perform the PMF measurement may be further based on whether the second wireless network is available to the WTRU.

In some implementations, the first wireless network and the second wireless network may be different networks of a same type. In some implementations, the first wireless network and/or the second wireless network may be any one of H-PLMN, V-PLMN, PNI-NPN or any combination thereof.

In some implementations, the first wireless network and the second wireless network may be any one of a fifth generation (5G) New Radio (NR), Non-Terrestrial 5G NR or Evolved Universal Terrestrial Radio Access (E-UTRA).

In some implementations, the information may comprise a command to trigger the PMF measurement.

In some implementations, a time duration for performing the PMF measurement may be received from the first wireless network.

In some implementations, the method 600 may include determining that the first wireless network has initiated a network-side PMF measurement based on the information.

In some implementations, the method 600 may include determining to perform the PMF measurement periodically based on the information.

In some implementations, the PMF measurement may be a first PMF measurement and the parameter is a first parameter, the method 600 may further include performing a second PMF measurement for the second PDU session to obtain a second parameter associated with the second PMF measurement, compensating the first parameter and/or the second parameter based on a compensation value and comparing the first parameter and the second parameter based on the compensation.

In some implementations, the method 600 may include performing a traffic operation based on the comparing, wherein the traffic operation is one of traffic steering, traffic switching, or traffic splitting.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, ¶ 6 or means-plus-function claim format, and any claim without the terms “means for” is not so intended.

What is claimed is:

1. A method performed by a wireless transmit/receive unit (WTRU), the method comprising:
transmitting a request to establish a first protocol data unit (PDU) session over a first wireless network;
receiving, from the first wireless network, information for triggering a performance management function (PMF) measurement for the first PDU session;
determining to perform the PMF measurement based on the information;
performing the PMF measurement to obtain a parameter associated with the PMF measurement;
determining that the parameter satisfies at least one criterion; and
in response to determining that the parameter satisfies the at least one criterion, transmitting a request to establish a second PDU session over a second wireless network.

2. The method of claim 1, further comprising:
receiving, from the first wireless network, criterion information indicative of the at least one criterion.

3. The method of claim 1, wherein:
the information comprises at least one of a reference signal received power (RSRP) threshold, reference signal received quality (RSRQ) threshold, or signal-to-interference ratio (SINR) threshold; and
the at least one criterion is a Round-Trip Time (RTT) threshold and/or a Packet Loss Rate (PLR) threshold.

4. The method of claim 1, wherein the parameter is associated with at least one of a round-trip time (RTT) or a packet loss rate (PLR).

5. The method of claim 1, wherein the determining to perform the PMF measurement is further based on whether the second wireless network is available to the WTRU.

6. The method of claim 1, wherein the first wireless network and/or the second wireless network is any one of a fifth generation (5G) New Radio (NR), Non-Terrestrial 5G NR, or Evolved Universal Terrestrial Radio Access (E-UTRA).

7. The method of claim 1, wherein the first wireless network and/or the second wireless network is any one of a Home-Public Land Mobile Network (H-PLMN), Visited-Public Land Mobile Network (V-PLMN), or Public Network Integrated-Non-Public Network (PNI-NPN).

8. The method of claim 1, wherein the information comprises a command to trigger the PMF measurement.

9. The method of claim 1, further comprising:
receiving, from the first wireless network, a time duration for performing the PMF measurement.

10. The method of claim 1, further comprising:
determining that the first wireless network has initiated a network-side PMF measurement based on the information.

11. The method of claim 1, further comprising:
determining to perform the PMF measurement periodically based on the information.

12. The method of claim 1, wherein the PMF measurement is a first PMF measurement and the parameter is a first parameter, the method further comprising:
performing a second PMF measurement for the second PDU session to obtain a second parameter associated with the second PMF measurement;
compensating the first parameter and/or the second parameter based on a compensation value; and
comparing the first parameter and the second parameter based on the compensation.

13. The method of claim 12, further comprising:
performing a traffic operation based on the comparing, wherein the traffic operation is one of traffic steering, traffic switching, or traffic splitting.

14. A wireless transmit/receive unit (WTRU) comprising:
a processer; and
a transceiver coupled to the processer, wherein the WTRU is to:
transmit a request to establish a first protocol data unit (PDU) session over a first wireless network;
receive, from the first wireless network, information for triggering a performance management function (PMF) measurement for the first PDU session;
determine to perform the PMF measurement based on the information;
perform the PMF measurement to obtain a parameter associated with the PMF measurement;
determine that the parameter satisfies at least one criterion; and
in response to determining that the parameter satisfies the at least one criterion, transmit a request to establish a second PDU session over a second wireless network.

15. The WTRU of claim 14, wherein the WTRU is further to:
receive, from the first wireless network, criterion information indicative of the at least one criterion.

16. The WTRU of claim 14, wherein:
the information comprises at least one of a reference signal received power (RSRP) threshold, reference signal received quality (RSRQ) threshold, or signal-to-interference ratio (SINR) threshold; and
the at least one criterion is a Round-Trip Time (RTT) threshold and/or a Packet Loss Rate (PLR) threshold.

17. The WTRU of claim 14, wherein the parameter is associated with at least one of a round-trip time (RTT) or a packet loss rate (PLR).

18. The WTRU of claim 14, wherein the determining to perform the PMF measurement is further based on whether the second wireless network is available to the WTRU.

19. The WTRU of claim 14, wherein the first wireless network and/or the second wireless network is any one of a fifth generation (5G) New Radio (NR), Non-Terrestrial 5G NR, or Evolved Universal Terrestrial Radio Access (E-UTRA).

20. The WTRU of claim 14, wherein the first wireless network and/or the second wireless network is any one of a Home-Public Land Mobile Network (H-PLMN), Visited-Public Land Mobile Network (V-PLMN), or Public Network Integrated-Non-Public Network (PNI-NPN).
